(19) United States
(12) Patent Application Publication
(10) Pub. No.: US 2005/0031299 A1
(43) Pub. Date: Feb. 10, 2005

(54) METHOD FOR PROCESSING AUDIOVISUAL SIGNALS

(76) Inventors: Chih-Chuan Cheng, Taipei City (TW); Wen-Sung Tsai, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/709,592

(22) Filed: May 17, 2004

(30) Foreign Application Priority Data
Aug. 6, 2003 (TW) 092121556

(51) Int. Cl. H04N 5/76; G11B 27/00

(52) U.S. Cl. 386/52; 386/55

(57) ABSTRACT

A method for processing AV signals includes (a) receiving a first AV signal by a receiving module, (b) transmitting the first AV signal to a coder and decoder (CODEC) by a control unit to convert the first AV signal into a second AV signal, (c) storing the second AV signal in a storing device connected to the CODEC and the control unit, wherein the storing device has stored a third AV signal, (d) while performing step (a) to (c), transmitting the third AV signal to the CODEC by the control unit, and decoding the third AV signal into a fourth AV signal by the CODEC, (e) transmitting the fourth AV signal to an editing module by the control unit, and (f) editing the fourth AV signal into a fifth AV signal by the editing module.

### BACKGROUND OF INVENTION

1. Field of the Invention

The present invention relates to a method for processing audiovisual (AV) signals, and more specifically, to a method for editing AV data stored in a digital recorder while the digital recorder is recording.

2. Description of the Prior Art

AV signals are conventionally stored in analog format. However, due to the disadvantages of the conventional analog recorders such as difficulties in long-term storage, distortion and deterioration of the image quality after repeated use of the recorded AV signals, limited recording time, occupied preservation space, damage of magnetic head, and waste of time in checking the recorded data, digital recording devices are expected to replace the conventional analog recorders. Digital recording devices convert analog signals into digital signals and store them on an optical disc or a hard disc after compression, so that the image quality of the recorded data will not deteriorate even after the recorded data is played or copied repeatedly, or stored for a long time. Owing to the blooming development of the computer technology, the operating clock of a processor becomes faster, the compression technique is greatly improved, and the capacity of the storage media is getting larger and larger. Therefore, it is consequential that the digital recording devices such as digital video recorders (DVR) and digital camcorders are going to flourish vigorously.

Generally, the digital recording devices can be divided as PC framework design and non-PC framework design. The digital recording device of PC framework design is built by ready-made computer components combined with an image-capturing card. This kind of digital recording device utilizes various kinds of OS (operating system) operation platforms. Most functions of such a digital recording device, such as the image displaying, the screen division, the data compression and storage, the movement comparison, the data search and playing, and the network transmission, are controlled by software and processed by a central processing unit (CPU). Although this kind of digital recording device has advantages of high processing efficiency and function expandability, it also has the following disadvantages. Firstly, since hardware and software are designed for different environments or requirements, the incompatibility issue or the improper design will lead to system conflict. Secondly, the operating system, drivers, and applications are all stored on a hard disk, so that files may be damaged due to errors on reading, writing, or overwriting. Thirdly, the PC framework design digital recording device has a low stability due to the difficulties in quality control caused by lack of required circuit components, i.e., the hardware specification needs to be modified or the original circuit components need to be replaced with compatible components manufactured by other factories when the originally required circuit components are out of production or out of stock. Fourthly, professional personnel are required to assemble the hardware and install the operating system, which cause problems with after-sales services.

As for the non-PC framework design digital recording device, it is an independent device separate from the computer, such as a digital recorder or a digital camcorder. This type of device has simpler functions. Besides, like a CD or DVD player, it is designed to have proper circuits, IC devices, and independent control system according to specified functions, and thus its system is stable and easy for operation. What differs from the PC framework design digital recording devices is that most functions of the non-PC framework design digital recording device are controlled by hardware. For example, the non-PC framework design digital recording device uses different IC chips to handle different functions, and the related control programs are burned in a programmable IC or a read-only memory (ROM), so the control programs will not be damaged. Another advantage of non-PC framework design digital recording devices is that, as using the conventional recorders, it is unnecessary to use complex installation programs and to change the hardware. Furthermore, it is easy to be setup and has a user-friendly interface similar to that of the conventional recorder. Therefore, the non-PC framework design digital recording device quite matches the consumers” requirements and has less breakdown issues.

Concerning the conventional non-PC framework design digital recording devices, recorded AV data is stored in a storage device such as a DVD, a VCD, or a magnetic tape, and then transmitted to a computer for editing. The data can be edited only after the recording is completed. Therefore, it is not only inconvenient for editing AV data, but also inefficient in AV data processing. In addition, it also runs counter to the trend of a user-friendly interface.

### SUMMARY OF INVENTION

It is therefore a primary objective of the present invention to provide a method for processing AV signals so that the AV data stored in a digital recording device can be edited or modified simultaneously while the digital recording device is recording.

Briefly summarized, the method for processing AV signals of the present invention includes (a) receiving a first AV signal by a receiving module, (b) transmitting the first AV signal to a coder and decoder (CODEC) by a control unit in order to convert the first AV signal into a second AV signal, wherein the CODEC is connected to the receiving module and the control unit, and the control unit controls the CODEC, (c) storing the second AV signal in a storing device connected to the CODEC and the control unit, wherein the control unit can control the storing device and the storing device has stored a third AV signal, (d) while performing steps (a) to (c), transmitting the third AV signal to the CODEC by the control unit, and decoding the third AV signal into a fourth AV signal by the CODEC, (e) transmitting the fourth AV signal to an editing module by the control unit, and (f) editing the fourth AV signal to form a fifth AV signal by the editing module.

The advantage of the present invention is that while a digital recording device is recording, the AV data stored thereon can be edited or modified simultaneously. Therefore, the AV signals can be edited conveniently and efficiently in time, which conforms to the trend of increased user-friendly interfaces.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a digital recorder according to the first embodiment of the present invention;

FIG. 2 is a block diagram of the digital recorder according to the first embodiment of the present invention;

FIG. 3 is a flowchart of recording and playing recorded data simultaneously by the digital recorder of the present invention;

FIG. 4 is a flowchart of recording and editing recorded data simultaneously by the digital recorder of the present invention;

FIG. 5 is a perspective view of a digital camcorder according to the second embodiment of the present invention;

FIG. 6 is a block diagram of the digital camcorder according to the second embodiment of the present invention;

FIG. 7 is a flowchart of recording and playing recorded data simultaneously by the digital camcorder of the present invention; and

FIG. 8 is a flowchart of recording and editing recorded data simultaneously by the digital camcorder of the present invention.

### DETAILED DESCRIPTION

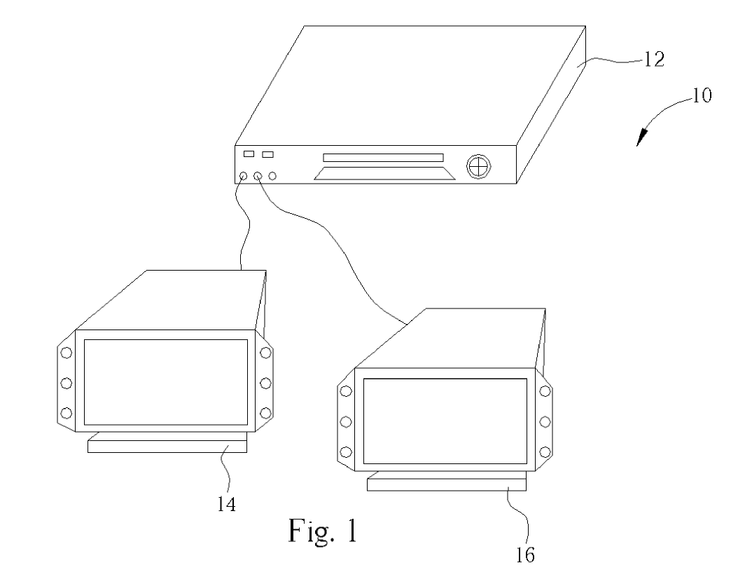

With reference to FIG. 1, there is shown a digital recorder 10 of the first embodiment according to the present invention. The digital recorder 10 has a housing 12, a first display device 14, and a second display device 16. Both of the first display device 14 and the second display device 16 are connected to the digital recorder 10. The first display device 14 and the second display device 16 can be two audiovisual output devices, such as televisions, monitors, or any kind of display devices combined with a speaker, for displaying AV signals outputted from the digital recorder 10.

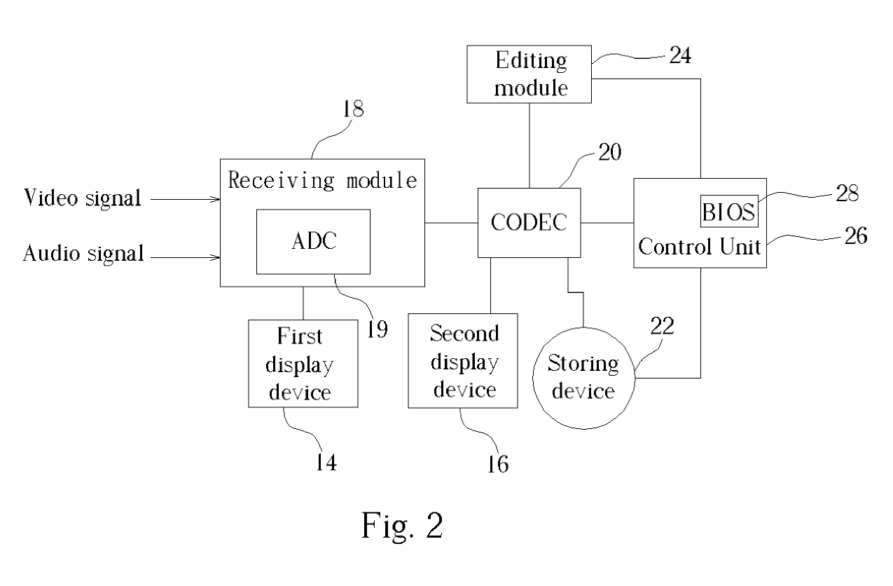

With reference to FIG. 1 and FIG. 2, FIG. 2 is a block diagram of the digital recorder 10 according to the present invention. The digital recorder 10 includes a receiving module 18, a coder and decoder (CODEC) 20, a storing device 22, an editing module 24, and a control unit 26. The receiving module 18 is installed within the housing for receiving external AV signals. The receiving module 18 has an analog-to-digital converter (ADC) 19 for converting analog AV signals received by the receiving module 18 into corresponding digital AV signals. The coder and decoder (CODEC) 20 is connected to the receiving module 18 and installed within the housing for encoding external AV signals. The storing device 22 is connected to the CODEC 20 and installed within the housing for storing the AV signals encoded by the CODEC 20. Moreover, the storing device 22 can be a read-only memory device such as a DVD drive or a VCD drive, or a flash memory compatible with CF, SD or MMC format, or a magnetic disc drive such as a hard disc drive or a micro driver. The editing module 24 is connected to the CODEC 20 and installed within the housing for editing or modifying the AV signals delivered from the CODEC 20. The control unit 26 is connected to the CODEC 20 and the storing device 22 and installed within the housing for controlling the CODEC 20, the storing device 22, and the editing module 24. The control unit 26 further has a basic input/output system (BIOS) 28 for providing necessary programs for the digital recorder 10. In addition, the first display device 14 is connected to the receiving module 18 of the digital recorder 10, and the second display device 16 is connected to the CODEC 20.

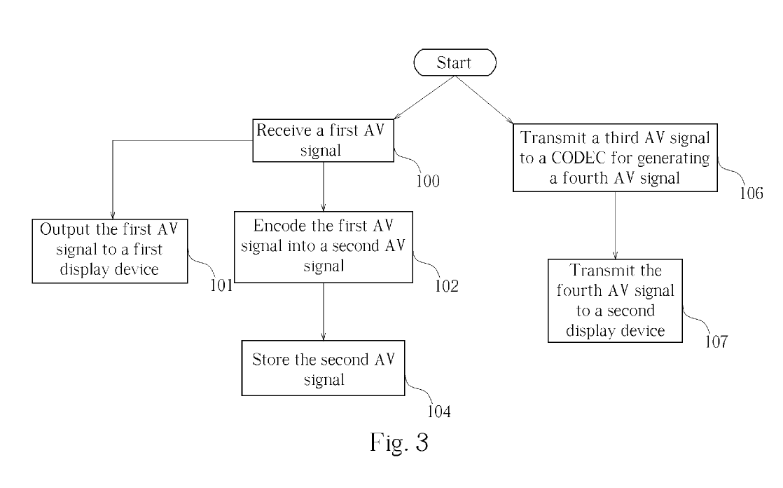

With reference to FIG. 3, FIG. 3 is a flowchart showing how the digital recorder 10 records and plays recorded data simultaneously according to the present invention. The steps in FIG. 3 are illustrated as follows:

Step100: Let the receiving module receive a first AV signal.

Step101: After performing Step100, the control unit outputs the first AV signal received by the receiving module to the first display device.

Step102: After performing Step100, the control unit transmits the first AV signal received by the receiving module to the CODEC, and the CODEC encodes the first AV signal from the receiving module into a second AV signal.

Step104: The control unit stores the second AV signal encoded by the CODEC in the storing device.

Step106: The control unit transmits a third AV signal previously stored in the storing device to the CODEC. The third AV signal can either be generated through Step100, Step102 and Step104, or be already stored in the storing device. Then, the CODEC decodes the third AV signal into a fourth AV signal.

Step107: The control unit transmits the fourth AV signal decoded by the CODEC to the second display device.

While performing Step100, Step101, Step102, and Step104, Step106 and Step107 can be performed at the same time. In other words, the digital recorder 10 can read AV signals previously stored in the storing device 22 and play AV signals stored in the storing device 22 through the second display device 16 while recording and playing the recorded AV data through the first display device 14. In such a manner, synchronized recording and playing can be realized.

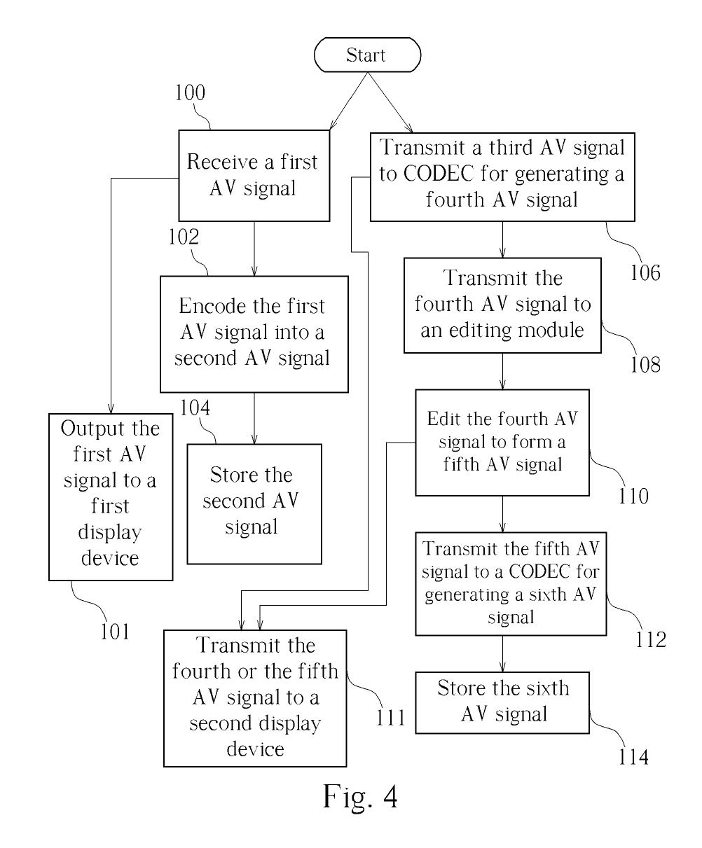

With reference to FIG. 4, FIG. 4 is a flowchart showing how the digital recorder 10 plays, records and edits recorded data simultaneously. The steps in FIG. 4 are illustrated as follows:

Step100: Let the receiving module receive the first AV signal.

Step101: After performing Step100, the control unit outputs the first AV signal received by the receiving module to the first display device.

Step102: After performing Step100, the control unit transmits the first AV signal received by the receiving module to the CODEC, and the CODEC encodes the first AV signal from the receiving module into the second AV signal.

Step104: The control unit stores the second AV signal encoded by the CODEC in the storing device.

Step106: The control unit transmits the third AV signal previously stored in the storing device to the CODEC. The third AV signal can either be generated through Step100, Step102 and Step104, or be already stored in the storing device. Then, the CODEC decodes the third AV signal from the storing device into the fourth AV signal.

Step108: The control unit transmits the fourth AV signal decoded by the CODEC to the editing module.

Step110: The editing module edits or modifies the fourth AV signal from the CODEC into a fifth AV signal.

Step112: The control unit transmits the fifth AV signal edited by the editing module to the CODEC, and the CODEC encodes the fifth AV signal from the editing module into a sixth AV signal.

Step114: The control unit stores the sixth AV signal in the storing device.

Step111: After performing Step106 or Step110, the control unit can respectively transmit the fourth AV signal or the fifth AV signal edited or modified by the editing module to the second display device.

While performing Step100, Step101, Step102, and Step104 in FIG. 4, Step106, Step108, Step110, Step111, Step112, and Step114 can be performed at the same time. In other words, the digital recorder 10 can edit or modify AV signals previously stored in the storing device 22 and play AV data being edited through the second display device 16 while recording and playing the AV data being recorded through the first display device 14. Therefore, synchronized playing, recording and editing can be realized, and the digital recorder 10 can edit the recorded data while it is recording.

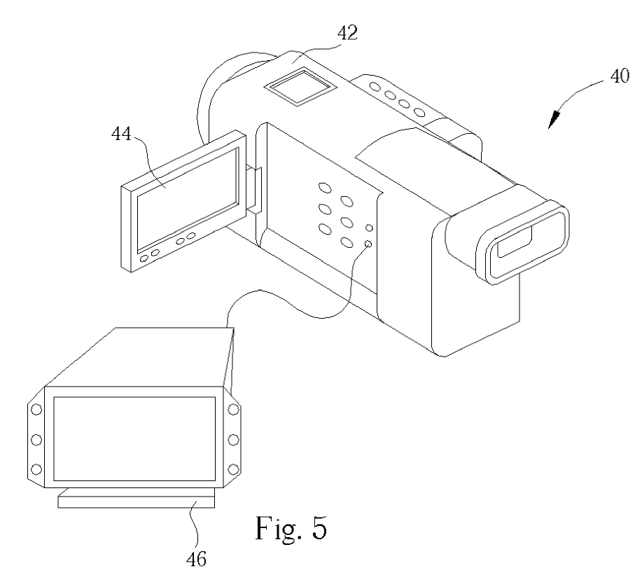

With reference to FIG. 5, FIG. 5 is a perspective view of a digital camcorder 40 of the second embodiment according to the present invention. The digital camcorder 40 includes a housing 42 and a third display device 44 mounted on the housing 42. Additionally, a fourth display device 46 is connected to the digital camcorder 40. The fourth display device 46 can be an audiovisual output device, such as a television, a monitor, or any kind of display device combined with a speaker, and is used for displaying AV signals outputted from the digital camcorder 40.

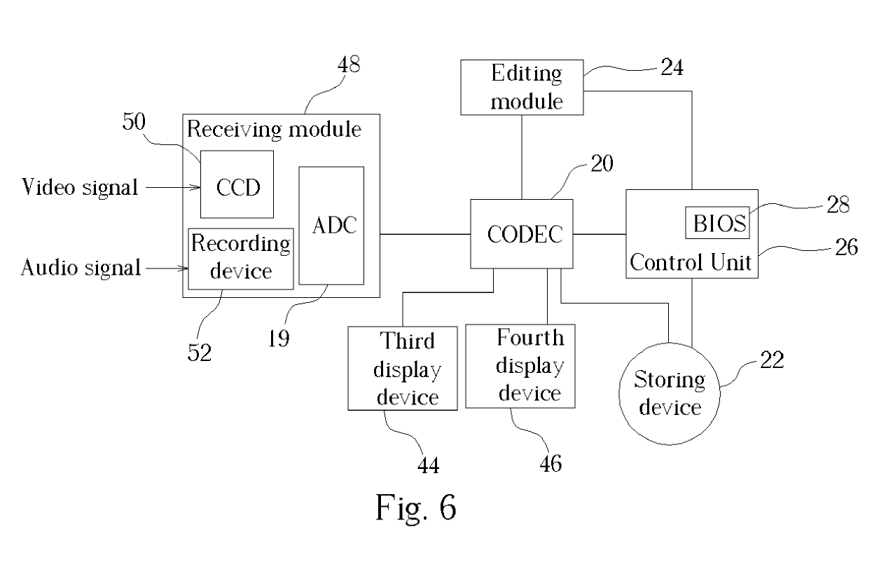

With reference to FIG. 5 and FIG. 6, FIG. 6 is a block diagram of the digital camcorder 40 according to the present invention. Similar to the digital recorder 10 in the previous embodiment, the digital camcorder 40 includes a receiving module 48, a CODEC 20, a storing device 22, an editing module 24, and a control unit 26. The receiving module 48 is mounted on the housing for receiving external AV signals. The receiving module 48 has a charge-coupled device (CCD) 50 for receiving external video optical signals and converting them into electrical signals, a recording device 52 for receiving external audio signals, and an ADC 19 for converting analog AV signals received by the receiving module 48 into corresponding digital AV signals. The CODEC 20 is connected to the receiving module 48 and installed within the housing for encoding external AV signals. The storing device 22 is connected to the CODEC 20 and installed within the housing for storing the AV signals encoded by the CODEC 20. The editing module 24 is connected to the CODEC 20 and installed within the housing for editing or modifying the AV signals from the CODEC 20. Additionally, the control unit 26 is connected to the CODEC 20 and the storing device 22 and installed within the housing for controlling the CODEC 20, the storing device 22, and the editing module 24. The control unit 26 further has a BIOS 28 to provide necessary programs for the operation of the digital camcorder 40. Moreover, the third display device 44 and the fourth display device 46 are connected to the CODEC 20 of the digital camcorder 40.

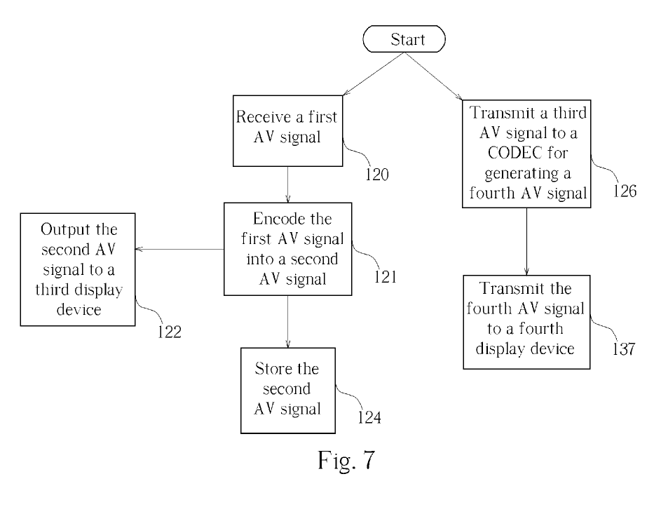

With reference to FIG. 7, FIG. 7 is a flowchart showing how the digital camcorder 40 records and plays recorded data according to the present invention. The steps in FIG. 7 are illustrated as follows:

Step120: The CCD of the receiving module receives an external video optical signal and converts it into an electrical signal, and the recording device receives an external audio signal. Thus, a first AV signal is formed.

Step121: The control unit transmits the first AV signal received by the receiving module to the CODEC, and the CODEC encodes the AV signal from the receiving module into a second AV signal.

Step122: After performing Step121, the control unit outputs the second AV signal to the third display device.

Step124: The control unit stores the second AV signal encoded by the CODEC into the storing device.

Step126: The control unit transmits a third AV signal previously stored in the storing device to the CODEC. The third AV signal can either be generated through Step120, Step121 and Step124, or be already stored in the storing device. Then, the CODEC decodes the third AV signal into a fourth AV signal.

Step137: The control unit transmits the fourth AV signal decoded by the CODEC to the fourth display device.

While performing Step120, Step121, Step122, and Step124 in FIG. 7, Step126 and Step137 can be performed at the same time. In other words, the digital camcorder 40 can read AV signals previously stored in the storing device 22 and play AV signals previously stored in the storing device 22 through the fourth display device 46 while recording and playing the AV data being recorded through the third display device 44. In such a manner, synchronized recording and playing can be realized.

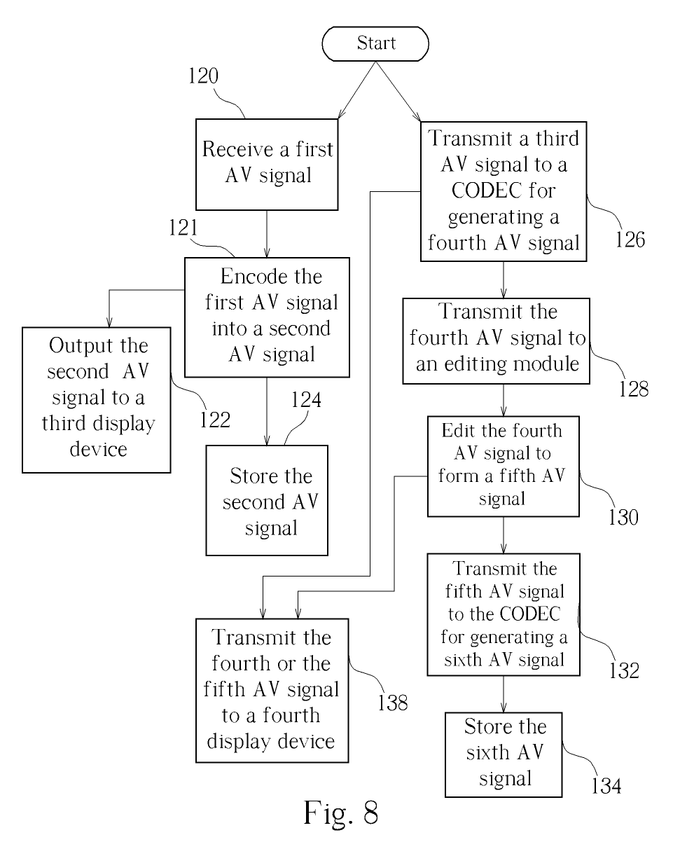

With reference to FIG. 8, FIG. 8 is a flowchart showing how the digital camcorder 40 records and edits recorded data simultaneously. The steps in FIG. 8 are illustrated as follows:

Step120: The CCD of the receiving module receives an external video optical signal and converts it into an electrical signal, and the recording device receives an external audio signal. Thus, a first AV signal is formed.

Step121: The control unit transmits the first AV signal received by the receiving module to the CODEC, and the CODEC encodes the AV signals from the receiving module into a second AV signal.

Step122: After proceeding Step121, the control unit outputs the second AV signal to the third display device.

Step124: The control unit stores the second AV signal encoded by the CODEC in the storing device.

Step126: The control unit transmits a third AV signal previously stored in the storing device to the CODEC. The third AV signal can either be generated through Step120, Step122 and Step124, or be already stored in the storing device. Then, the CODEC decodes the third AV signal into a fourth AV signal.

Step128: The control unit transmits the fourth AV signal decoded by the CODEC to the editing module.

Step130: The editing module edits or modifies the fourth AV signal from the CODEC into a fifth AV signal.

Step132: The control unit transmits the fifth AV signal edited by the editing module to the CODEC, and then the CODEC encodes the fifth AV signal from the editing module into a sixth AV signal.

Step134: The control unit stores the sixth AV signal in the storing device.

Step138: After performing Step126 or Step130, the control unit can respectively transmit the fourth AV signal or the fifth AV signal edited or modified by the editing module to the fourth display device.

While performing Step120, Step121, Step122, and Step124 in FIG. 8, Step126, Step128, Step130, Step132, Step134 and Step138 can also be performed at the same time. In other words, the digital camcorder 40 can edit or modify AV signals previously stored in the storing device 22 and play AV data being edited through the fourth display device 46 while recording and playing the AV data being recorded through the third display device 44. In such a manner, synchronized recording and editing can be realized, which allows the digital camcorder 40 to edit the recorded data while recording.

Compared with the prior art, the digital recorder according the present invention can play, edit, or modify stored AV data while recording, so that it is more convenient and efficient for editing AV signals. Therefore, the digital recorder according to the present invention can provide a user-friendly interface, which matches the development trend in information appliances.

Those skilled in the art will readily observe that numerous modifications and alterations of the device may be made while retaining the teachings of the invention. Accordingly, the above disclosure should be construed as limited only by the metes and bounds of the appended claims.

1. A method for processing audiovisual (AV) signals comprising:
(a) receiving a first AV signal by a receiving module;
(b) transmitting the first AV signal to a coder and decoder (CODEC) by a control unit in order to convert the first AV signal into a second AV signal, wherein the CODEC is connected to the receiving module and the control unit, and the control unit controls the CODEC;
(c) storing the second AV signal in a storing device connected to the CODEC and the control unit, wherein the control unit can control the storing device, and the storing device has stored a third AV signal;
(d) while proceeding step (a) to (c), transmitting the third AV signal to the CODEC by the control unit, and decoding the third AV signal into a fourth AV signal by the CODEC;
(e) transmitting the fourth AV signal to an editing module by the control unit; and
(f) editing the fourth AV signal to form a fifth AV signal by the editing module.

2. The method of claim 1, wherein after the fifth AV signal is encoded into a sixth AV signal by the CODEC, the control unit stores the sixth AV signal in the storing device.

3. The method of claim 1, wherein the first AV signal is displayed on a first display device.

4. The method of claim 3, wherein the first display device is connected to the receiving module.

5. The method of claim 1, wherein the fourth AV signal and the fifth AV signal are displayed on a second display device.

6. The method of claim 5, wherein the second display device is connected to the CODEC.

7. The method of claim 1, wherein the receiving module has an analog-to-digital converter (ADC) for receiving an analog AV signal and converting the analog AV signal into a corresponding digital AV signal.

8. The method of claim 1, wherein the control unit has a basic input/output system (BIOS).

9. A method for processing AV signals comprising:
(a) receiving a first AV signal by a receiving module;
(b) transmitting the first AV signal to a CODEC by a control unit in order to convert the first AV signal into a second AV signal, wherein the CODEC is connected to the receiving module and the control unit, and the control unit controls the CODEC;
(c) storing the second AV signal in a storing device connected to the CODEC and the control unit, wherein the control unit can control the storing device;
(d) receiving a third AV signal by the receiving module;
(e) transmitting the third AV signal to the CODEC by the control unit in order to convert the third AV signal into a fourth AV signal;
(f) storing the fourth AV signal in the storing device;
(g) while performing steps (d) to (f), transmitting the second AV signal to the CODEC by the control unit, and decoding the second AV signal into a fifth AV signal by the CODEC;
(h) transmitting the fifth AV signal to an editing module by the control unit, wherein the control unit controls the editing module, and the editing module is connected to the control unit and the CODEC; and
(i) editing the fifth AV signal to form a sixth AV signal by the editing module.

10. The method of claim 9, wherein the first AV signal is displayed on a first display device.

11. The method of claim 10, wherein the first display device is connected to the receiving module.

12. The method of claim 9, wherein the fifth AV signal and the sixth AV signal are displayed on a second display device.

13. The method of claim 12, wherein the second display device is connected to the CODEC.

14. The method of claim 9, wherein the receiving module has an ADC for receiving an analog AV signal and converting the analog AV signal into a corresponding digital AV signal.

15. The method of claim 9, wherein the control unit has a BIOS.

16. A method for processing AV signals by a digital recording device comprising:
(a) receiving a first AV signal by a receiving module;
(b) transmitting the first AV signal to a CODEC by a control unit in order to convert the first AV signal into a second AV signal and display the second AV signal on a first display device, wherein the CODEC is connected to the receiving module and the control unit, and the control unit controls the CODEC;
(c) storing the second AV signal in a storing device connected to the CODEC and the control unit, wherein the control unit can control the storing device;
(d) receiving a third AV signal by the receiving module;
(e) transmitting the third AV signal to the CODEC by the control unit in order to convert the third AV signal into a fourth AV signal and display the fourth AV signal on the first display device;
(f) storing the fourth AV signal in the storing device;
(g) while performing steps (d) to (f), transmitting the second AV signal to the CODEC by the control unit, and decoding the second AV signal into a fifth AV signal by the CODEC;
(h) transmitting the fifth AV signal to an editing module by the control unit, wherein the control unit controls the editing module, and the editing module is connected to the control unit and the CODEC;
(i) editing the fifth AV signal to form a sixth AV signal by the editing module, wherein both the fifth AV signal and the sixth AV signal can be displayed on a second display device;
(j) transmitting the sixth AV signal to the CODEC by the control unit in order to convert the sixth AV signal into a seventh AV signal; and
(k) storing the seventh AV signal in the storing device by the control unit.

17. The method of claim 16, wherein the first display device is connected to the CODEC.

18. The method of claim 16, wherein the second display device is connected to the CODEC.

19. The method of claim 16, wherein the digital recording device is a digital camcorder.
